(19) United States
(12) Patent Application Publication
(10) Pub. No.: US 2024/0426403 A1
(43) Pub. Date: Dec. 26, 2024

(54) REINFORCED THERMOPLASTIC MULTILAYER HOSE FOR HIGH TEMPERATURE AND PRESSURE TRANSPORT OF FLUIDS

(71) Applicant: Dennis M. D’HONDT, Ray, MI (US)

(72) Inventor: Dennis M. D’HONDT, Ray, MI (US)

(73) Assignee: GM GLOBAL TECHNOLOGY OPERATIONS LLC, Detroit, MI (US)

(21) Appl. No.: 18/339,392

(22) Filed: Jun. 22, 2023

(51) Int. Cl. F16L 11/08; F16L 33/207

(52) U.S. Cl. CPC F16L 11/08; F16L 11/085; F16L 33/2073; F16L 2011/047

(57) ABSTRACT

A multilayer hose includes a liner layer and an outer sleeve circumferentially surrounding the liner layer. The liner layer has an inner circumferential surface defining a tubular flowthrough passage extending in an axial direction through the multilayer hose. The liner layer comprises ethylene chlorotrifluoroethylene. The inner circumferential surface of the liner layer may be electrically conductive and may have a surface resistivity of less than or equal to about 1×10⁶ Ohms per square at 20 degrees Celsius, or the inner circumferential surface of the liner layer may be electrically insulating and may have a surface resistivity of greater than 1×10⁶ Ohms per square at 20 degrees Celsius. The outer sleeve defines an outer circumferential surface of the multilayer hose and comprises a reinforcing material.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to thermoplastic hoses, and more particularly to thermoplastic hoses having a layered structure for transport of fluids at high temperatures and pressures.

Hoses or flexible pipes used for conveyance of fluids, including automotive vehicle fluids, are oftentimes made of thermoplastic materials and may have a layered structure that provides the hoses with a desirable combination of mechanical strength, low permeability, chemical and thermal resistance, wear resistance, light weight, and flexibility over a desired operating temperature range.

### SUMMARY

A multilayer hose in accordance with one or more embodiments of the present disclosure comprises a liner layer and an outer sleeve circumferentially surrounding the liner layer. The liner layer has an inner circumferential surface defining a tubular flowthrough passage extending in an axial direction through the multilayer hose. The liner layer comprises ethylene chlorotrifluoroethylene. The inner circumferential surface of the liner layer is electrically conductive and has a surface resistivity of less than or equal to about 1×10⁶ Ohms per square at 20 degrees Celsius. The outer sleeve defines an outer circumferential surface of the multilayer hose and comprises a reinforcing material.

The ethylene chlorotrifluoroethylene may constitute, by weight, greater than or equal to about 80% to less than or equal to about 99.8% of the liner layer.

The liner layer may comprise a continuous matrix phase and a dispersed phase distributed throughout the continuous matrix phase. The continuous matrix phase may comprise the ethylene chlorotrifluoroethylene and the dispersed phase may comprise an electrically conductive agent.

The electrically conductive agent may comprise carbon.

The continuous matrix phase may constitute, by weight, greater than or equal to about 80% to less than or equal to about 99.8% of the liner layer. The electrically conductive agent may constitute, by weight, greater than or equal to about 0.2% to less than or equal to about 20% of the liner layer.

The liner layer may have a bilayer structure comprising an electrically conductive inner layer and an electrically insulating outer layer circumferentially surrounding the inner layer. The electrically conductive inner layer may define the inner circumferential surface of the liner layer and may comprise a continuous matrix phase comprising ethylene chlorotrifluoroethylene and a dispersed phase comprising an electrically conductive agent. The electrically insulating outer layer may comprise ethylene chlorotrifluoroethylene and may have a surface resistivity of greater than 1×10⁶ Ohms per square at 20 degrees Celsius.

The outer sleeve may be braided, woven, knit, or spiral wrap.

The reinforcing material may comprise metal, glass, ceramic, plastic, a carbon-based material, or a combination thereof.

The reinforcing material may comprise stainless steel or fiberglass.

In aspects, the reinforcing material may comprise braided fiberglass. In such case, the multilayer hose may further comprise an adhesive layer disposed between the liner layer and the outer sleeve. The adhesive layer may comprise a thermoplastic polymer.

The multilayer hose may be substantially free of perfluorooctanoic acid, perfluorooctane sulfonate, polytetrafluoroethylene, and combinations thereof.

The multilayer hose may be configured to withstand temperatures of greater than or equal to about −40 degrees Celsius to less than or equal to about 180 degrees Celsius. The multilayer hose may be configured to withstand internal pressures of up to about 21 megapascals.

The multilayer may further comprise a fitting disposed in an open end of the multilayer hose and a ferrule coupled to the fitting and crimped around the open end of the multilayer hose such that a fluid tight seal is formed between the fitting and the multilayer hose.

A multilayer hose in accordance with one or more embodiments of the present disclosure comprises a liner layer and an outer sleeve circumferentially surrounding the liner layer. The liner layer has an inner circumferential surface defining a tubular flowthrough passage extending in an axial direction through the multilayer hose. The liner layer comprises ethylene chlorotrifluoroethylene. The inner circumferential surface of the liner layer is electrically insulating and has a surface resistivity of greater than 1×10⁶ Ohms per square at 20 degrees Celsius. The outer sleeve defines an outer circumferential surface of the multilayer hose and comprises a reinforcing material.

The ethylene chlorotrifluoroethylene may constitute, by weight, greater than or equal to about 80% to less than or equal to about 99.8% of the liner layer.

The outer sleeve may be braided, woven, knit, or spiral wrap.

The reinforcing material may comprise metal, glass, ceramic, plastic, a carbon-based material, or a combination thereof.

In aspects, the reinforcing material may comprise braided fiberglass. In such case, the multilayer hose may further comprise an adhesive layer disposed between the liner layer and the outer sleeve. The adhesive layer may comprise a thermoplastic polymer.

The multilayer hose may be substantially free of perfluorooctanoic acid, perfluorooctane sulfonate, polytetrafluoroethylene, and combinations thereof.

The multilayer may further comprise a fitting disposed in an open end of the multilayer hose and a ferrule coupled to the fitting and crimped around the open end of the multilayer hose such that a fluid tight seal is formed between the fitting and the multilayer hose.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic cross-sectional view of a multilayer hose according to one or more embodiments of the present disclosure.

FIG. 2 is a schematic cross-sectional view of a multilayer hose according to another embodiment of the present disclosure.

FIG. 3 is a schematic cross-sectional view of a hose assembly including the multilayer hose of FIG. 1.

In the drawings, reference numbers may be reused to identify similar and/or identical elements.

### DETAILED DESCRIPTION

A multilayer hose according to the present disclosure comprises a liner layer and an outer sleeve circumferentially surrounding the liner layer. The liner layer comprises ethylene chlorotrifluoroethylene (ECTFE) and provides the multilayer hose with low permeability, high chemical and thermal resistance over a wide operating temperature range, and high strength. The outer sleeve comprises a reinforcing material that provides the multilayer hose with increased strength, chemical and thermal resistance, and optionally improved barrier properties (reduced permeability of fluids).

Polytetrafluoroethylene (PTFE) is a polymer of the perfluorinated chemical compound tetrafluoroethylene (C₂F₄) and has a carbon-only polymer backbone with fluorine atoms directly attached thereto. PTFE consists entirely of carbon and fluorine atoms and does not include any carbon-hydrogen (C—H) bonds. In other words, the carbon backbone of PTFE is fully fluorinated (perfluorinated). On the other hand, ECTFE is an alternating copolymer of ethylene (C₂H₄ or H₂C═CH₂) and chlorotrifluoroethylene (CFCl═CF₂) and has a carbon-only polymer backbone with fluorine, hydrogen, and chlorine atoms directly attached thereto. The presence of the hydrogen and chlorine atoms directly attached to the carbon backbone of ECTFE means that ECTFE is only partially fluorinated (polyfluorinated). ECTFE is not a perfluorinated chemical compound. As such, the liner layer may be formulated without the use of perfluorinated chemicals (PFCs), e.g., perfluorooctanoic acid (PFOA), perfluorooctane sulfonate (PFOS), polytetrafluoroethylene (PTFE), and combinations thereof. In addition, the ECTFE may provide the liner layer with relatively high strength and creep resistance, as compared to PTFE, and may allow the multilayer hose to be used in applications where the hose is crimped to form a fluid tight seal with another device. The presently disclosed multilayer hose is light weight and has exceptional chemical, thermal, and mechanical properties at relatively low cost, as compared to multilayer hoses that rely on PFAS for sufficient chemical resistance and low permeability.

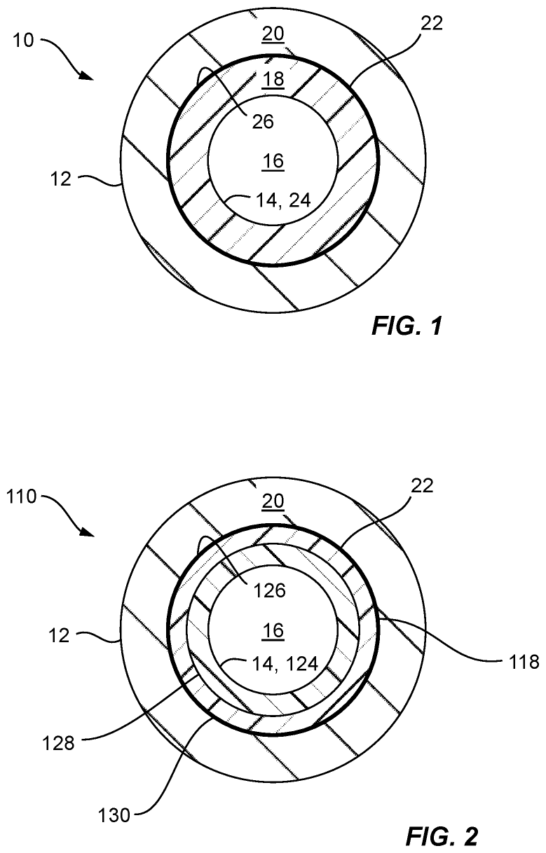

FIG. 1 depicts a multilayer hose 10 having an outer circumferential surface 12 and an inner circumferential surface 14 defining a tubular flowthrough passage 16 extending in an axial direction therethrough. The multilayer hose 10 includes a liner layer 18, a reinforcement layer 20, and optionally an adhesive layer 22. The multilayer hose 10 may be used for conveying or carrying various types of automotive fluid, including fuel (e.g., volatile liquid fuel and/or heavy liquid fuel), engine oil, power steering fluid, transmission fluid, brake fluid, and/or engine coolant. Fuel, engine oil, power steering fluid, transmission fluid, and brake fluid are nonaqueous fluids and are generally hydrocarbon-based. On the other hand, engine coolant is oftentimes an aqueous fluid and may comprise a mixture of water and an alcohol (e.g., ethylene glycol and/or propylene glycol). Examples of volatile liquid fuels include gasoline and aliphatic alcohols, e.g., methanol, ethanol, propanol, and/or butanol. Examples of heavy liquid fuel include diesel fuel.

The multilayer hose 10 may be used in automotive vehicles and may have a wide operating temperature range of from about −40 degrees Celsius (° C.) to about 180° C. The multilayer hose 10 has relatively high strength and may be used to convey or carry fluids in the tubular flowthrough passage 16 at internal pressures of greater than or equal to about 0 pounds per square inch (psi), optionally 0.5 psi, or optionally 80 psi to less than or equal to about 21 megapascals (MPa) (˜3045 psi), optionally about 200 psi, optionally about 150 psi, or optionally about 100 psi. The multilayer hose 10 may have a thickness, defined between the outer circumferential surface 12 and the inner circumferential surface 14, of greater than or equal to about 1 millimeter (mm) to less than or equal to about 5 mm.

The liner layer 18 is the innermost layer of the multilayer hose 10 and is configured to create a physical barrier that prevents fluid flowing in the tubular flowthrough passage 16 from penetrating, permeating, or decomposing the multilayer hose 10. The liner layer 18 has an inner surface 24 and an opposite outer surface 26, with the inner surface 24 defining the inner circumferential surface 14 of the multilayer hose 10. The liner layer 18 comprises ethylene chlorotrifluoroethylene (ECTFE). ECTFE is a semicrystalline partially fluorinated aliphatic copolymer of ethylene and chlorotrifluoroethylene. The ECTFE provides the liner layer 18 with exceptional thermal and chemical resistance, impact strength, creep resistance, and good processability for extrusion and injection molding applications, as well as the ability to be crimped, for example, to fittings and couplings. Notably, the ECTFE provides the liner layer 18 with high chemical resistance against fuels.

The liner layer 18 may be electrically insulating or electrically conductive, depending on the application of use. It may be beneficial for the liner layer 18 to be electrically conductive in application where the multilayer hose 10 is used for conveying or carrying fuel (e.g., liquid fuel), engine oil, power steering fluid, and/or transmission fluid. The liner layer 18 may be electrically insulating in applications where the multilayer hose 10 is used for conveying or carrying engine coolant and/or brake fluid. In aspects where the liner layer 18 is electrically insulating, the liner layer 18 may consist essentially of or consist of ECTFE. In aspects where the liner layer 18 is electrically insulating, the liner layer 18 may have a surface resistivity of greater than 1×10⁶ Ohms per square (Ohm/sq) or optionally 1×10¹⁴ Ohm/sq at 20 degrees Celsius.

In aspects where the liner layer 18 is electrically conductive, the liner layer 18 has a composite structure comprising a continuous matrix phase and a dispersed phase distributed throughout the continuous matrix phase. The continuous matrix phase may constitute, by weight, greater than or equal to about 80%, optionally about 90%, or optionally about 95% to less than or equal to about 99.8%, optionally about 99%, or optionally about 97% of the liner layer 18. The dispersed phase may constitute, by weight, greater than or equal to about 0.2%, optionally about 1%, or optionally about 3% to less than or equal to about 20%, optionally about 10%, or optionally about 5% of the liner layer 18.

The continuous matrix phase comprises ECTFE and may consist essentially of or consist of ECTFE. For example, the ECTFE may constitute, by weight, greater than or equal to about 80%, optionally about 90%, or optionally about 95% to less than or equal to about 99.8%, optionally about 99%, or optionally about 97% of the liner layer 18.

The dispersed phase comprises an electrically conductive agent. The electrically conductive agent is distributed throughout at least a portion of the liner layer 18 and provides the liner layer 18 with desired electrical conductivity. For example, the electrically conductive agent may provide the liner layer 18 with a surface resistivity of less than or equal to about 1×10⁶ Ohms per square (Ohm/sq) or optionally about 1×10⁵ Ohm/sq at 20 degrees Celsius. The electrically conductive agent may be distributed substantially uniformly throughout the continuous matrix phase or the concentration of the electrically conductive agent may vary within the composite structure of the liner layer 18. For example, in aspects, the concentration of the electrically conductive agent may be relatively high in regions of the liner layer 18 disposed along the inner circumferential surface 14 of the multilayer hose 10 and relatively low in regions of the liner layer 18 disposed along the outer surface 26 of the liner layer 18. The electrically conductive agent may comprise particles of a carbon-based material, an electrically conductive polymer, or a combination thereof. Examples of electrically conductive carbon-based materials include carbon black (e.g., acetylene black), graphite, graphene (e.g., graphene nanoplatelets), carbon nanotubes (e.g., single-walled and/or multiwalled carbon nanotubes), carbon fibers (e.g., carbon nanofibers), and/or Ketjenblack®. Examples of electrically conductive polymers include polyaniline, polythiophene, polyacetylene, and/or polypyrrole. The electrically conductive agent may constitute, by weight, greater than or equal to about 0.2%, optionally about 1%, or optionally about 3% to less than or equal to about 20%, optionally about 10%, or optionally about 5% of the liner layer 18.

The liner layer 18 may be substantially free of perfluorinated chemicals (PFCs). For example, the liner layer 18 may be substantially free of perfluorooctanoic acid (PFOA), perfluorooctane sulfonate (PFOS), polytetrafluoroethylene (PTFE), and combinations thereof. The liner layer 18 may have a thickness, defined between the inner surface 30 and the outer surface 32, of greater than or equal to about 0.1 mm to less than or equal to about 1 mm.

The reinforcement layer 20 is the outermost layer of the multilayer hose 10 and circumferentially surrounds the liner layer 18. The reinforcement layer 20 defines the outer circumferential surface 12 of the multilayer hose 10. The reinforcement layer 20 is configured to provide the multilayer hose 10 with flexibility, durability, and resistance to abrasion, wear, impacts, and weathering (e.g., resistance to ozone and ultraviolet light). The reinforcement layer 20 comprises a reinforcing material. Examples of reinforcing materials include metals, glass, ceramics, plastics, carbon-based materials, and combinations thereof. Examples of reinforcing metals include steel, stainless steel, nickel, copper, and/or aluminum. Examples of reinforcing glass materials include amorphous silica, alumino-borosilicate glass (e.g., E-glass), alkali-lime glass (e.g., A-glass and/or C-glass), alumino-lime silicate glass (e.g., E-CR-glass), borosilicate glass (e.g., D-glass), and/or alumino silicate glass (e.g., R-glass and/or S-glass). Examples of reinforcing ceramic materials include crystalline silica (SiO₂), alumina (Al₂O₃), zirconia (Zr₂O₃). Examples of reinforcing plastic materials include thermosetting polymers (e.g., epoxy, polyester resin, and/or vinyl ester resin) and/or thermoplastic polymers (e.g., polyamides, such as Kevlar, and/or polyesters, such as polyethylene terephthalate). Examples of reinforcing carbon-based materials include carbon fiber and/or graphite. In aspects, the reinforcing material may comprise fiberglass including a plurality of glass fibers in a polymer matrix. In aspects, the reinforcement layer 20 may be braided, woven, knit, or spiral wrap.

The optional adhesive layer 22 is disposed between the liner layer 18 and the reinforcement layer 20 and provides a strong physical bond therebetween. The adhesive layer 22 may comprise a thermoplastic polymer, e.g., a polyolefin resin. The specific composition of the thermoplastic polymer may be selected based on the composition of the liner layer 18 and/or the reinforcement layer 20.

In aspects, the multilayer hose 10 may consist of the liner layer 18 and the reinforcement layer 20 and may be free of additional layers underlying the liner layer 18, overlying the reinforcement layer 20, or disposed between the liner layer 18 and the reinforcement layer 20. In other aspects, the multilayer hose 10 may consist of the liner layer 18, the reinforcement layer 20, and the adhesive layer 22 and may be free of additional layers underlying the liner layer 18, overlying the reinforcement layer 20, or disposed between the liner layer 18 and the reinforcement layer 20.

FIG. 2 depicts another embodiment of a multilayer hose 110. The multilayer hose 110 is similar in many respects to the multilayer hose 10 and like numerals between the embodiments generally designate like or corresponding elements in the drawing figures. Accordingly, the description of the multilayer hose 10 is incorporated into that of the multilayer hose 110, and description of subject matter common to the multilayer hose 10 and the multilayer hose 110 generally may not be repeated here.

The multilayer hose 110 includes a liner layer 118, a reinforcement layer 20, and optionally an adhesive layer 22. The liner layer 118 is the innermost layer of the multilayer hose 110 and has an inner surface 124 and an opposite outer surface 126, with the inner surface 124 defining the inner circumferential surface 14 of the multilayer hose 110. The liner layer 118 has a bilayer structure comprising an inner layer 128 and an outer layer 130 circumferentially surrounding the inner layer 128. The inner layer 128 of the liner layer 118 defines the inner surface 124 of the liner layer 118 and the inner circumferential surface 14 of the multilayer hose 110. The outer layer 130 defines the outer surface 126 of the liner layer 118. The inner layer 128 is electrically conductive and may have substantially the same chemical composition, physical and electrical properties as that of the liner layer 18. On the other hand, the outer layer 130 is electrically insulating and may have substantially the same composition as that of the continuous matrix phase of the liner layer 18. For example, the outer layer 130 may comprise, consist essentially of, or consist of ECTFE. The outer layer 130 may be substantially free of the electrically conductive agent. The outer layer 130 may have a surface resistivity of greater than 1×10⁶ Ohm/sq or optionally 1×10¹⁴ Ohm/sq at 20 degrees Celsius.

In aspects, the multilayer hose 110 may consist of the liner layer 118 and the reinforcement layer 20 and may be free of additional layers underlying the liner layer 118, overlying the reinforcement layer 20, or disposed between the liner layer 118 and the reinforcement layer 20. In other aspects, the multilayer hose 110 may consist of the liner layer 118, the reinforcement layer 20, and the adhesive layer 22 and may be free of additional layers underlying the liner layer 118, overlying the reinforcement layer 20, or disposed between the liner layer 118 and the reinforcement layer 20.

The multilayer hose 10, 110 may be manufactured via an extrusion process, e.g., a coextrusion process. In an extrusion process, a material having the same composition as that of one of the layers (e.g., 18, 20) is melted, fed to an extruder, and forced through a die at high temperature and pressure to from one of the layers. In a coextrusion process, multiple molten materials having different compositions corresponding to the different layers (e.g., 18, 20, 128, 130) may be fed into separate extruders and then forced through a single die, where the molten materials are combined and deposited concentrically and simultaneously around and over each other such that the layers adhere to each other and produce the multilayer hose 10, 110. Alternatively, one or more of the interior layers (e.g., 18, 128) of the multilayer hose 10, 110 may be preformed (e.g., by extrusion) and then one or more of the surrounding layers (e.g., 20, 130) may be formed over and concentrically around the one or more preformed interior layers. In some aspects, the multilayer hose 10, 110 may be manufactured via multiple extrusion and/or coextrusion processes. Prior to extrusion (or coextrusion) the starting materials may be dried to remove residual water content therefrom. In aspects where the reinforcement layer 20 is braided, woven, knit, or spiral wrap, the reinforcement layer 20 may be braided, woven, or otherwise formed around the liner layer 18, 118 after formation thereof in a continuous process, for example, by passing the liner layer 18, 118 through a braider. In aspects where the multilayer hose 10, 110 includes the adhesive layer 22, the adhesive layer 22 may be applied to the liner layer 18, 118 prior to forming the reinforcement layer 20 on the outer surface 26, 126 thereof.

During the extrusion process, the thickness of the layers (e.g., 18, 20, 128, 130) may be measured (e.g., by a laser) and controlled or adjusted by control or adjustment of the extruder settings as layers are extruded. The multilayer hose 10, 110 may be cooled as it exits the extruder and either placed into coils or cut to a desired length. Each cut length of the multilayer hose 10, 110 may be placed in a form to take a preconfigured shape and heated (e.g., on a belt proceeding through an oven) to soften and conform the multilayer hose 10, 110 to the shape induced by the form.

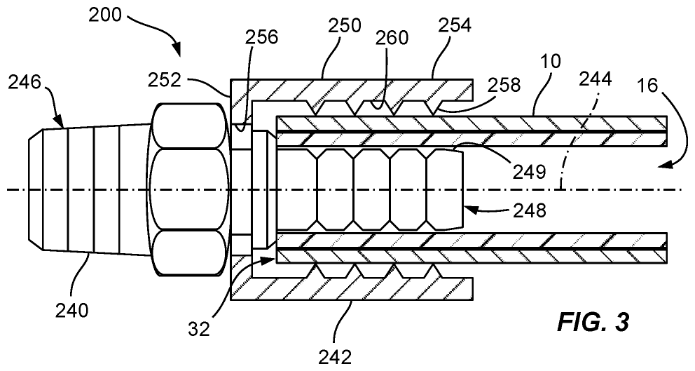

FIG. 3 depicts a hose assembly 200 including the multilayer hose 10, a fitting 240, and optionally a ferrule 242. The hose assembly 200 has a central axis 244 aligned with a central axis of the multilayer hose 10 and with the tubular flowthrough passage 16. The fitting 240 is configured to fluidly couple the multilayer hose 10 to another device and includes a first end 246, an opposite second end 248 having an outer circumferential surface 249, and a fluid flow passage (not shown) extending therethrough and aligned with the central axis 244 of the hose assembly 200. The hose assembly 200 is shown and described with respect to the multilayer hose 10, but such description applies equally to the multilayer hose 110. For example, in embodiments, the multilayer hose 110 may replace the multilayer hose 10 shown in FIG. 3.

As shown in FIG. 3, the multilayer hose 10 has an open end 32. In assembly, the second end 248 of the fitting 240 is received in the open end 32 of the multilayer hose 10 and disposed partway in the tubular flowthrough passage 16 such that the fluid flow passage of the fitting 240 is in fluid communication with the tubular flowthrough passage 16 of the multilayer hose 10. In aspects, the second end 248 of the fitting 240 may be press-fit into the open end 32 of the multilayer hose 10 such that the outer circumferential surface 249 engages the inner circumferential surface 14 of the multilayer hose 10 and forms a fluid tight seal therebetween.

In other aspects, the ferrule 242 may be used to form a fluid tight seal between the fitting 240 and the multilayer hose 10. In such case, the ferrule 242 is configured to retain the second end 248 of the fitting 240 in the tubular flowthrough passage 16 defined by the multilayer hose 10. The ferrule 242 has a substantially cylindrical body 250 including a collar 252 and an engagement portion 254. The collar 252 defines a socket 256 and is configured to receive and couple the ferrule 242 to the fitting 240. The engagement portion 254 is configured to couple the fitting 240 to the multilayer hose 10 and may include a plurality of teeth 258 disposed on an inner circumferential surface 260 thereof. In other embodiments, the inner circumferential surface 260 of the engagement portion 254 may be smooth and substantially free of surface protrusions.

During assembly of the hose assembly 200, the fitting 240 is received in the socket 256 and coupled to the collar 252 of the ferrule 254, for example, by threading. The second end 248 of the fitting 240 is received in the open end 32 of the multilayer hose 10 and then the engagement portion 254 of the ferrule 242 is crimped around the open end 32 of the multilayer hose 10 (and around the second end 248 of the fitting 240) such that the plurality of teeth 258 engage the outer circumferential surface 12 of the multilayer hose 10 and form a fluid tight seal around the outer circumferential surface 12 of the multilayer hose 10 and between the fitting 240 and the multilayer hose 10.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s), as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. A multilayer hose comprising:
a liner layer having an inner circumferential surface defining a tubular flowthrough passage extending in an axial direction through the multilayer hose, the liner layer comprising ethylene chlorotrifluoroethylene, the inner circumferential surface of the liner layer being electrically conductive and having a surface resistivity of less than or equal to about 1×10⁶ Ohms per square at 20 degrees Celsius; and
an outer sleeve circumferentially surrounding the liner layer and defining an outer circumferential surface of the multilayer hose, the outer sleeve comprising a reinforcing material.

2. The multilayer hose of claim 1, wherein the ethylene chlorotrifluoroethylene constitutes, by weight, greater than or equal to about 80% to less than or equal to about 99.8% of the liner layer.

3. The multilayer hose of claim 1, wherein the liner layer comprises:
a continuous matrix phase; and
a dispersed phase distributed throughout the continuous matrix phase,
wherein the continuous matrix phase comprises the ethylene chlorotrifluoroethylene and the dispersed phase comprises an electrically conductive agent.

4. The multilayer hose of claim 3, wherein the electrically conductive agent comprises carbon.

5. The multilayer hose of claim 3, wherein the continuous matrix phase constitutes, by weight, greater than or equal to about 80% to less than or equal to about 99.8% of the liner layer, and wherein the electrically conductive agent constitutes, by weight, greater than or equal to about 0.2% to less than or equal to about 20% of the liner layer.

6. The multilayer hose of claim 1, wherein the liner layer has a bilayer structure comprising:
an electrically conductive inner layer defining the inner circumferential surface of the liner layer and comprising a continuous matrix phase comprising ethylene chlorotrifluoroethylene and a dispersed phase comprising an electrically conductive agent; and
an electrically insulating outer layer circumferentially surrounding the inner layer, the electrically insulating outer layer comprising ethylene chlorotrifluoroethylene and having a surface resistivity of greater than 1×10⁶ Ohms per square at 20 degrees Celsius.

7. The multilayer hose of claim 1, wherein the outer sleeve is braided, woven, knit, or spiral wrap.

8. The multilayer hose of claim 1, wherein the reinforcing material comprises metal, glass, ceramic, plastic, a carbon-based material, or a combination thereof.

9. The multilayer hose of claim 1, wherein the reinforcing material comprises stainless steel or fiberglass.

10. The multilayer hose of claim 1, wherein the reinforcing material comprises braided fiberglass, and wherein the multilayer hose further comprises:
an adhesive layer disposed between the liner layer and the outer sleeve,
wherein the adhesive layer comprises a thermoplastic polymer.

11. The multilayer hose of claim 1, wherein the multilayer hose is substantially free of perfluorooctanoic acid, perfluorooctane sulfonate, polytetrafluoroethylene, and combinations thereof.

12. The multilayer hose of claim 1, wherein the multilayer hose is configured to withstand temperatures of greater than or equal to about −40 degrees Celsius to less than or equal to about 180 degrees Celsius, and wherein the multilayer hose is configured to withstand internal pressures of up to about 21 megapascals.

13. The multilayer hose of claim 1, further comprising:
a fitting disposed in an open end of the multilayer hose; and
a ferrule coupled to the fitting and crimped around the open end of the multilayer hose such that a fluid tight seal is formed between the fitting and the multilayer hose.

14. A multilayer hose comprising:
a liner layer having an inner circumferential surface defining a tubular flowthrough passage extending in an axial direction through the multilayer hose, the liner layer comprising ethylene chlorotrifluoroethylene, the inner circumferential surface of the liner layer being electrically insulating and has a surface resistivity of greater than 1×10⁶ Ohms per square at 20 degrees Celsius; and
an outer sleeve circumferentially surrounding the liner layer and defining an outer circumferential surface of the multilayer hose, the outer sleeve comprising a reinforcing material.

15. The multilayer hose of claim 14, wherein the ethylene chlorotrifluoroethylene constitutes, by weight, greater than or equal to about 80% to less than or equal to about 99.8% of the liner layer.

16. The multilayer hose of claim 14, wherein the outer sleeve is braided, woven, knit, or spiral wrap.

17. The multilayer hose of claim 14, wherein the reinforcing material comprises metal, glass, ceramic, plastic, a carbon-based material, or a combination thereof.

18. The multilayer hose of claim 14, wherein the reinforcing material comprises braided fiberglass, and wherein the multilayer hose further comprises:
an adhesive layer disposed between the liner layer and the outer sleeve,
wherein the adhesive layer comprises a thermoplastic polymer.

19. The multilayer hose of claim 14, wherein the multilayer hose is substantially free of perfluorooctanoic acid, perfluorooctane sulfonate, polytetrafluoroethylene, and combinations thereof.

20. The multilayer hose of claim 14, further comprising:
a fitting disposed in an open end of the multilayer hose; and
a ferrule coupled to the fitting and crimped around the open end of the multilayer hose such that a fluid tight seal is formed between the fitting and the multilayer hose.
